(19) United States
(12) Patent Application Publication
(10) Pub. No.: US 2006/0080256 A1
(43) Pub. Date: Apr. 13, 2006

(54) Method and system for establishing a trustworthy supplier

(76) Inventor: Yucel Karabulut, Dortmund (DE)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/964,459

(22) Filed: Oct. 12, 2004

(51) Int. Cl. H04L 9/00

(52) U.S. Cl. 705/50

(57) ABSTRACT

A system to establish a trustworthy supplier in an online commerce environment includes an aggregated service provider to represent a buyer to source and to evaluate a seller. The aggregated service provider collects the requirements from the buyer, the requirements including a product specification and a qualification of the seller. The aggregated service provider presents an invitation to the seller and requests the seller to submit a property certificate. The property certificate contains a qualification of the seller, which is affirmed by a trusted agent. The aggregated service provider evaluates the qualification of the seller based on the submitted property certificate. In addition, the aggregated service provider translates the properties into access rights to certain transaction documents, such as Requests For Quotation (RFQ).

### FIELD OF THE INVENTION

An embodiment relates generally to the field of online commerce. More particularly, an embodiment relates to a method and a system for establishing a trustworthy supplier in electronic environments, e.g., online trading environment, online shopping site, online auctioning site, online person-to-person trading site or other electronic environments where feedback of the participants are provided, including those within an Internet marketplace community.

### BACKGROUND OF THE INVENTION

The Internet and the World Wide Web (“Web”) have changed the landscape of information delivery and affected numerous aspects of life, including commerce. One benefit of this technological development is the ability to conduct business transactions globally via the Internet. As the volume of commerce conducted over the network continues to increase, collections of business units or organizations are working together to pool resources and expertise in order to achieve a common business objective. Organizations are sharing services and resources across enterprise boundaries in order to undertake collaborative projects that their participants could not undertake individually, or to offer composed services that could not be provided by individual organizations.

In this collaborative environment, a buyer often uses strategic sourcing process to find qualified sources to fulfill supply needs, negotiate agreements, manage contracts and evaluate seller qualifications. Often, the number of sellers available in the virtual world overwhelms the buyer, especially since the ability to verify and authenticate the identity and qualifications of the seller remains limited.

Moreover, security and trust, which form the core of any business transaction, are difficult to establish in the virtual world. Trust in a real world transaction is often provided through a physical meeting, reputation, recommendations or prior knowledge. In an electronic commerce environment, most business transactions occur between strangers that do not share a common security domain.

Some of the common online security issues include data eavesdropping, data tampering and entity repudiation. Often, credit card, social security and financial account numbers are stolen through data eavesdropping, whereby data remains intact but privacy is compromised. In a data-tampering event, the data is altered or replaced in a transaction. For example, someone can change the amount to be transferred to and from a bank account. In entity repudiation, the identity of the user is compromised. Often, data is passed to a person who poses as the intended recipient.

Many security and trust management technologies have been developed to meet the increasing demand for secure business transactions. One common security approach includes using the Public Key Infrastructure (PKI), which is the standard for public-key cryptographic security and is used to ensure the security of digital certificates. PKI infrastructure provides these security measures—user authentication, data integrity and confidentiality. With the PKI infrastructure, a pair of keys is used to provide strong authentication and encryption services. The key pair is associated with a user by the use of a certificate containing the user's public key and attributes associated with the user. Often, the certificate is digitally signed by a trusted third party, such as the Certification Authority (CA), and is valid only for a certain period of time. The public key associated with and certified by the certificate works with the corresponding private key possessed by the entity identified by the certificate. For example, to send data to an intended recipient, a sender first encrypts the data with the recipient's public key. Upon receiving the data, the recipient decrypts it with the corresponding private key. The PKI infrastructure is able to verify the identities of the participants through the certificate and maintain data integrity with the encryption technology.

### SUMMARY OF THE INVENTION

In one embodiment, a method, for automatically evaluating a participant in a trust management infrastructure, includes building a property certificate and establishing a security conversion policy that translates a property in the property certificate into a right to access a document, wherein the property represents qualifications of the participant.

According to another aspect of the present invention, a machine-readable medium is provided which comprises instructions, which when executed on a processor, caused the processor to perform the above-mentioned method.

### BRIEF DESCRIPTION OF THE DRAWINGS

The an embodiment of the present invention is illustrated by way of example and not limitation in the figures of the accompanying drawings, in which like references indicate similar elements and in which:

FIG. 1 is a network diagram depicting a system for establishing a trustworthy seller in accordance to one exemplary embodiment of the present invention;

FIG. 2 is a network diagram depicting a system for establishing a trustworthy seller in accordance to another exemplary embodiment of the present invention;

FIG. 3 is a block diagram of an exemplary embodiment of a property certificate of a seller;

FIG. 4 is a block diagram of an exemplary embodiment of a property certificate of an aggregated service provider;

FIG. 5 is a block diagram illustrating modules of a security server in accordance to an exemplary embodiment of the present invention;

FIG. 6 is a flow chart illustrating a prior art method of establishing a trustworthy seller;

FIG. 7 is a flow chart illustrating one approach of establishing a trustworthy seller in accordance with an exemplary embodiment of the present invention;

FIG. 8 is flow chart illustrating one approach of establishing a trustworthy seller and an aggregated service provider in accordance with an exemplary embodiment of the present invention;

FIG. 9 is a flow chart illustrating one approach of verifying a property certificate and providing authorization access to a RFQ in accordance with an exemplary embodiment of the present invention;

FIG. 10 is a diagrammatic representation of a machine within which a set of instructions, for causing the machine to perform any one of methods described herein, may be executed.

### DETAILED DESCRIPTION

A method and system to establish a trustworthy seller are described. In the following description, for purposes of explanation, numerous specific details are set forth in order to provide a thorough understanding of an embodiment of the present invention. It will be evident, however, to one skilled in the art that the present invention may be practiced without these specific details.

Strategic sourcing generally includes multiple acquisition platforms, such as auctions for buying or selling, private offers or public postings, basic requests for quotes and formal sealed requests for proposal. The aggregated service provider system described herein provides a secure and systematic approach for strategic sourcing using various acquisition platforms. In one embodiment, the aggregate service provider system collects the requirements of buyers, evaluates both existing and prospective sellers, presents invitation to sellers, accepts proposals from sellers and finally provides the buyers with the proposals.

Network Architecture

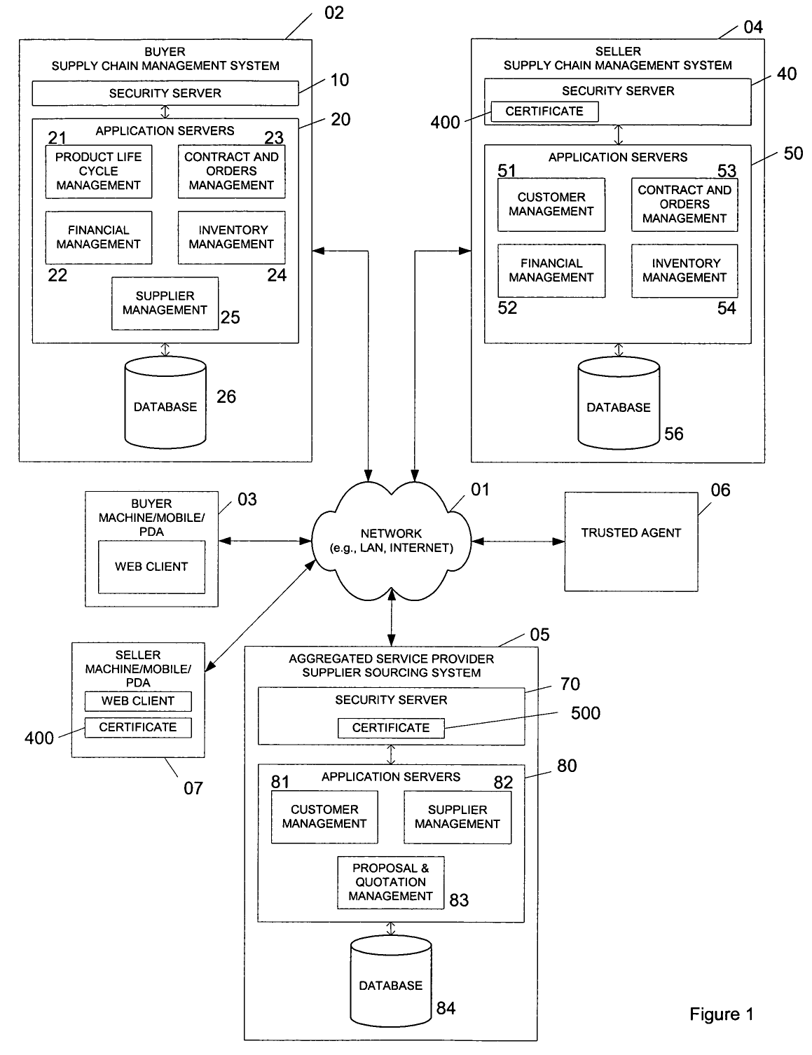

FIG. 1 is a network diagram depicting a commerce network, according to one exemplary embodiment. The network is made up of an aggregated service provider system 05 connected to buyer systems 02, 03, seller systems 04, 07 and trusted agent 06, via a network 01 (e.g., the Internet). The aggregated service provider system 05 receives requirements from buyer systems 02, 03, these requirements including product configurations and qualifications of potential sellers. A seller with matching qualifications will then be selected to respond with a proposal. For a seller to participate in the process, the seller system 04 has first to provide the aggregated service provider system 05 with a property certificate 400 containing the qualifications or credentials. In one embodiment, the certificate 400 may be provided by an independent trusted agent 06, which affirms the credentials and identity of the seller.

The aggregated service provider system 05 contains an application server 80 that is coupled to a security server 70. The security server 70 provides security measures relating to user authentication, data integrity and data confidentiality. In one example, when a potential seller presents a property certificate to the aggregated service provider system 05, the security server 70 verifies the identity of the seller and translates the properties into access rights to the relevant Request For Quotation (RFQ). The security server 70 manages the property certificate 500 of the aggregated service provider. This certificate may be presented to a seller or a buyer, who may wish to qualify the aggregated service provider before engaging with a business transaction. The qualifications or credentials of the aggregated service provider are encoded as properties in the digital certificate 500.

The aggregated service provider system 05 further contains application servers 80, which host one or more commerce applications (e.g., applications for managing buyer and seller relationships, analyzing the needs of buyer, evaluating and consolidating proposals from various sellers, etc.) In one exemplary embodiment, the application servers 80 provide the functions of customer management 81, supplier management 82, and proposal and quotation management 83. It will be appreciated that in alternative embodiments, the application servers 80 may include other applications, such as those hosted by the buyer system 02 or the seller system 04. For example, the aggregated service provider system 05 may contain the contract and orders management application 23 of the buyer system 02. The aggregated service provider system 05 therefore manages the contract and orders on behalf of the buyer.

The application servers 80 are in turn coupled to one or more databases 84 that store information of the buyers, sellers and business transactions. Though the security server 70, application servers 80 and databases 84 are presented within the same system 05, they are not restricted as such. For example, the database 84 may be remotely located from the aggregated service provider system 05.

The supply chain management system of the buyer system 02 provides product requirements and seller qualifications to the aggregated service provider system 05. The aggregated service provider system 05, on behalf of the buyer system 02, can then source and evaluate sellers based on the given information.

The buyer system 02 includes a security server 10 that protects business transactions conducted by the buyers with the external parties. The application servers 20 deliver the functions of managing business transactions. In this exemplary embodiment, the application servers 20 provide product life cycle management 21, financial management 22, contract and order management 23, inventory management 24 and supplier management 25. The application servers 20 may also host other business applications.

In another setup, the buyer machine 03 may be a simple machine, mobile device or PDA with a web client communicating with the other participants of the network 01.

The seller supply chain management system 04 is similar to that of a buyer supply chain management system 02. In this exemplary embodiment, the system 04 contains applications pertaining to supply management. These applications include customer management 51, financial management 52, contract and orders management 53 and inventory management 54.

The security server 40 of the system 04 presents the aggregated service provider system 05 with the digital property certificate of the sellers. The digital property certificate contains qualifications and credential information of the sellers. The aggregated service provider system 05 uses the digital property certificate to verify the identity and to evaluate the qualifications of the sellers. Likewise, the security server 40 may also verify and evaluate through a digital certificate mechanism, an aggregated service provider that is requesting for a proposal.

The seller system 07 is another embodiment of a seller, which includes a simple machine, mobile device or a PDA with a web client connected to the network 01. The system 07 further contains a digital certificate encoding the qualifications and credential information of the seller.

The trusted agent 06 acts as a trusted third party to ensure that participants who engage in online commerce can trust each other. The trusted agent 06 affirms that a participant, such as a seller, has a certain property and assigns the property as a digital certificate to the participant. A trusted agent 06 may be a certification authority (CA), a financial institute, a government board, a public reviewing community or a private reviewing community. The trustworthiness of the participants depends on the trust that is accorded on the trusted agent 06 who issued the certificates, as the trusted agent 06 has to accurately assess and verify the identity and properties of the participants.

In this exemplary embodiment, the system 05 shown in FIG. 1 employs a client-server architecture. The present invention is not limited to such architecture and could equally well find application in a distributed (e.g., a peer-to-peer) architecture system.

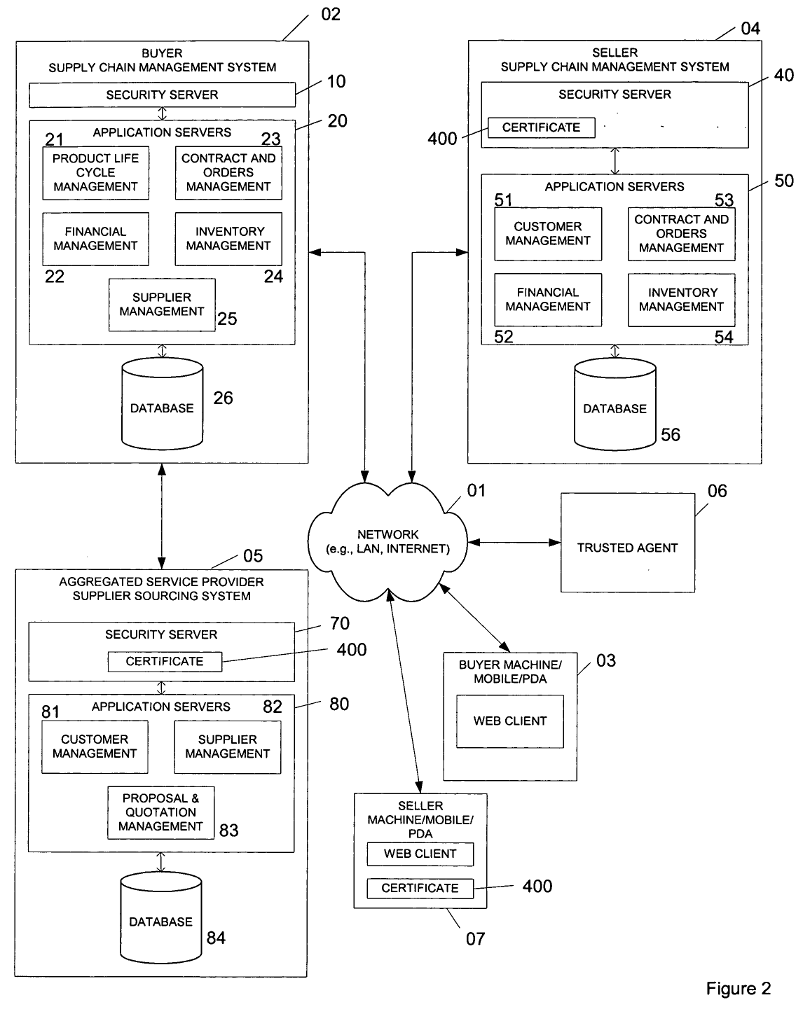

In addition, while FIG. 1 shows that the aggregated service provider system 05 is hosted in a different network domain from the buyer system 02, the aggregated service provider system 05 may be integrated as part of the buyer system 02. FIG. 2 illustrates an exemplary embodiment whereby the aggregated service provider system 05 and the buyer system 02 share the same network segment. This presents a case whereby the buyer owns the function of an aggregated service provider. Therefore, the aggregated service provider system 05 may be an independent organization or agency that manages sellers and buyers, or alternatively, the aggregated service provider system 05 may be an internal unit of a buyer system 02.

Security Architecture—Property Certificate

The security architecture of the exemplary embodiment uses property certificate for the purpose of assessing credibility and trustworthiness of the various participants. A trusted and licensed authority, such as a certification authority, may issue the certificate. The trusted authority affirms that a participant has a certain property by assigning the properties of the participant to the participant's certificate. This leverages the basic Public Key Infrastructure (PKI) functionalities required for the design of secure protocols for interaction between participants.

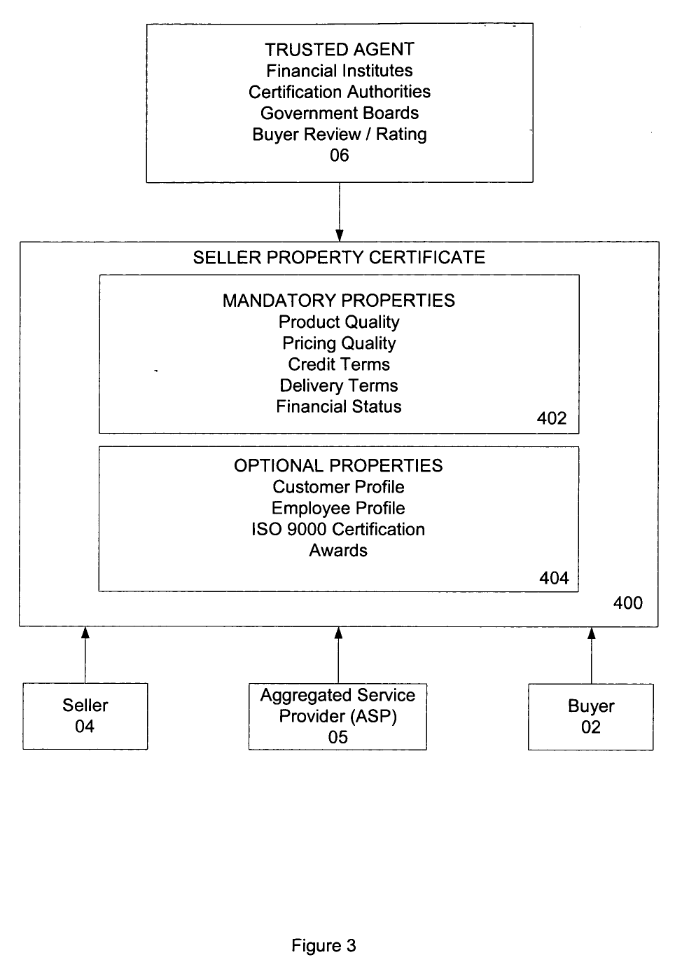

Referring to FIG. 3, a property certificate 400 of a seller system 04 may include mandatory properties 402 and optional properties 404. Mandatory properties 402 are properties that the seller is required to present in order for the buyer to consider engaging the seller in a business transaction. Some examples of mandatory properties 402 include but are not limited to, product quality, pricing quality, credit terms, delivery terms and financial status of the seller. Optional properties 404 are properties that provide additional credentials of a seller. The properties may be weighted so that the buyer or the aggregated service provider can quantify the qualification of the seller. In one example, the system of the aggregated service provider may be configured to read the weighted properties and automatically rank the potential sellers.

Seller, aggregated service provider, buyer, trusted agent or a combination of these, may define the types of mandatory properties 402 and optional properties 404. The trusted agent verifies the validity of these properties as submitted by the seller. Once the trusted agent has verified that a seller has a certain property, it assigns the property to the seller's certificate.

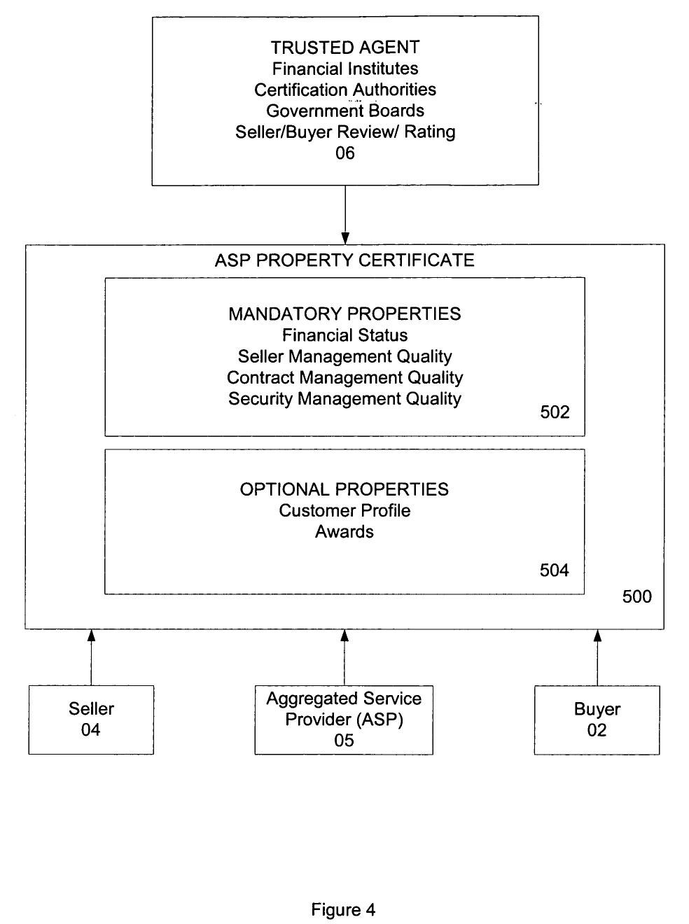

Now turning to FIG. 4, a property certificate 500 of an aggregated service provider system 05 is illustrated. The property certificate 500 of an aggregated service provider system 05 enables buyers and sellers to verify the aggregated service provider system 05. The property certificate 500 may include mandatory properties 502 and optional properties 504. Again, the properties may be established or defined by seller, aggregated service provider, buyer, trusted agent or a combination of these. In addition, the properties may be weighted.

It will be noted that the properties listed in the property certificates 400 and 500 may be modified to cater to the requirements of different transactions. For example, the mandatory properties and optional properties classification may not be necessary in some situations. They may be combined as a list of properties. In addition, a plurality of sellers may share a single certificate and, therefore, the certificate reflects combined qualities of the sellers. In this example, the plurality of sellers may be sellers that have already established a partnership or a relationship to work together, and may therefore be represented by a single virtual entity.

Security Architecture—Security Server

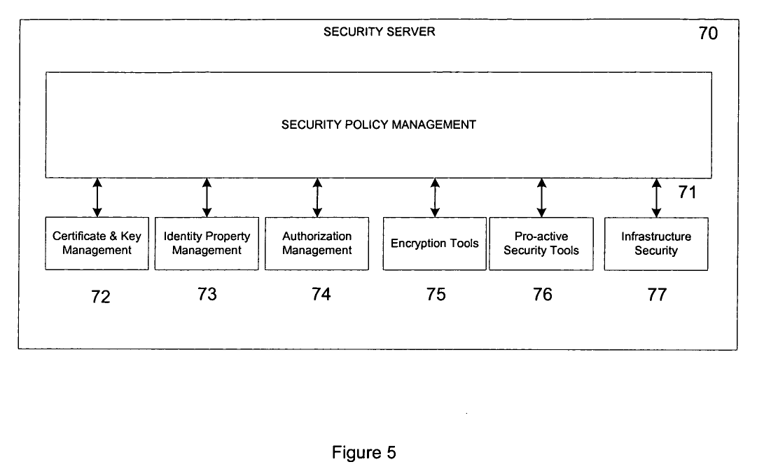

FIG. 5 illustrates an exemplary embodiment of the security server 70 found in the supplier sourcing system of the aggregated service provider system 05. The security server 70 contains several modules to provide secure business transactions and to deliver the functions of user authentication, data integrity and confidentiality. The security server 70 includes a security policy management module 71 that determines the rules and regulations of the various security modules 72-75. A certificate and key management module 72 is concerned with digital certificate, public and private key. The certificate and key management module 72 verifies and interprets the properties as presented in the digital certificate of a potential seller. If the properties are valid, the security policy management module 71 translates the properties according to the security policy. In one example, a seller with properties “A, B and C” may entitle him to access RFQ “X”, as defined by the security policy.

The security server 70 further includes identity property management 73 that verifies that a user is indeed who he/she claims to be. Authorization management 74 identifies the types of information to which an authorized user can have access. Encryption tools 75 encrypt and decrypt information to ensure data integrity. Pro-active security tools 76 include technology such as application and host based Intrusion Detection System (IDS). An infrastructure security module 77, such as a firewall, protects the physical network of the system.

Security Architecture—Protocol Layer

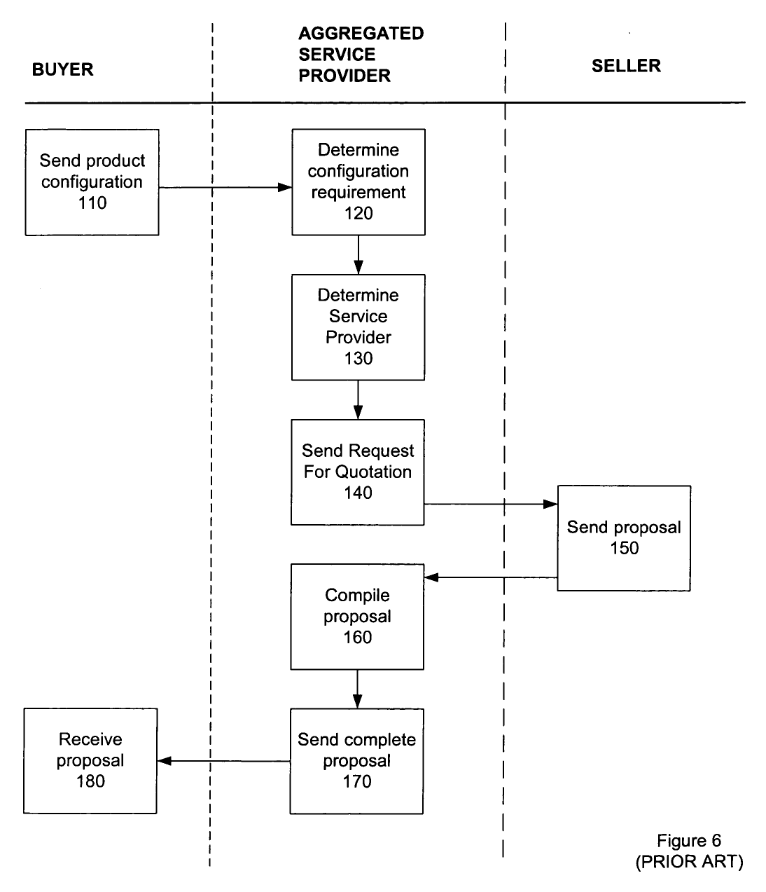

FIG. 6 illustrates a prior art approach of sourcing a seller. In this example, an aggregated service provider represents a buyer to source for appropriate sellers. The buyer first sends the product configuration to the aggregated service provider in operation 110. Upon receiving the information from the buyer, the aggregated service provider determines the configuration requirements in operation 120. In operation 130, the aggregated service provider further identifies the potential sellers that may be able to meet the product requirements. The approach of selecting the potential sellers is often based on the limited knowledge of the buyers. For examples, sellers whom the aggregated service provider already has an existing relationship or a seller who is well known in the industry. The aggregated service provider sends an RFQ to the sellers in operation 140. In response to the RFQ, the seller submits a quotation in operation 150. The aggregated service provider compiles the quotations from various suppliers in operation 160 and sends the complete quotation to the buyer in operation 170. The process is completed in operation 180 when the buyer receives the quotation.

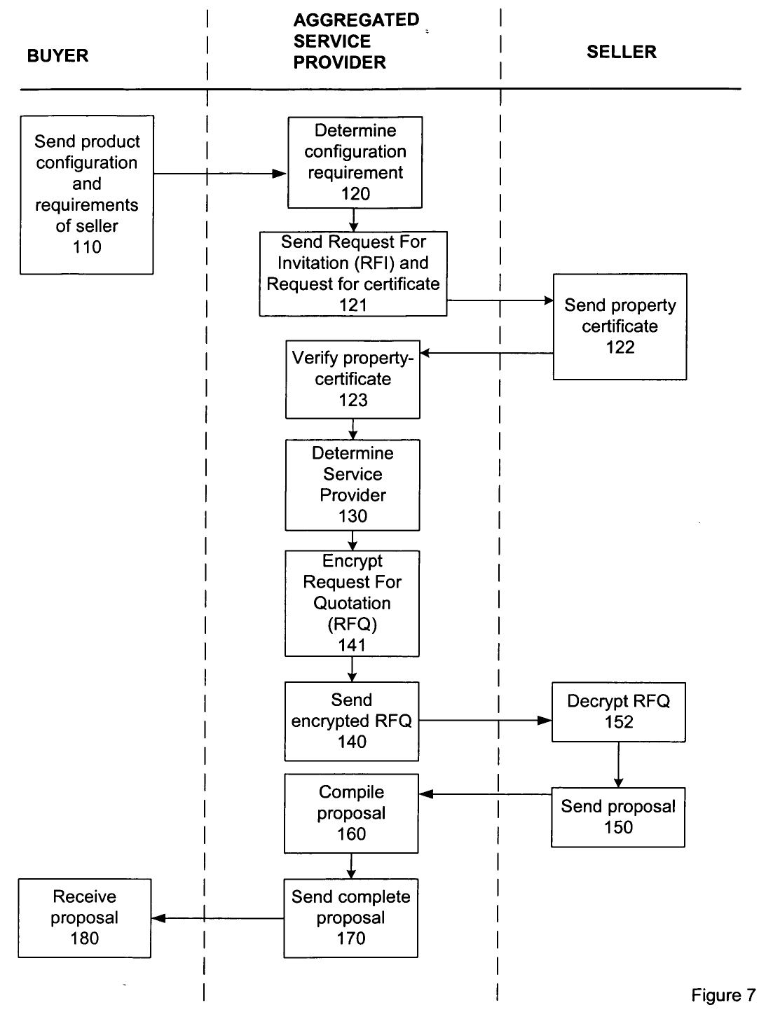

FIG. 7 illustrates one exemplary approach of the present invention whereby an aggregated service provider establishes the trustworthiness of a seller in the process of sourcing for the sellers. With the capability to verify the trustworthiness of a seller, the aggregated service provider is not restricted to work with sellers that it is familiar with.

The process begins at operation 110 when a buyer sends a product configuration and requirements of the seller to an aggregated service provider. The product configuration details the various parts required for a product or a service. For example, the buyer may be an aircraft engine manufacturer, sourcing for parts relating to an aircraft engine. The parts of an aircraft engine may include wires, motor, exhaust and engine mount. Different sellers may supply each part of the engine.

The requirements of the seller are the qualities and credentials that the buyer is looking for in a potential seller. The credentials requirements may be defined by the buyer, or by a third party, such as a standard board or a reviewing community. The requirements may even be based on consolidated credentials that were submitted by sellers in previous transactions. The properties may include price quality, product quality or reputation of the seller. In one embodiment, the properties may be weighted.

In operation 120, the aggregated service provider classifies the parts as specified in the product configuration. It then sends a Request for Invitation (RFI) to potential sellers for each part. The RFI protocol includes the description of the module and the required qualifications of the seller. The request may be in the form of sendRFI(module_A, required_qualification), thereby automatically including the required qualifications of the seller in the protocol.

The seller who chooses to respond to the RFI submits his property certificate in operation 122. Encoded in the property certificate are the credentials of the seller, which are affirmed by a trusted agent. A trusted agent may be a certification authority (CA), financial institute, government board, public reviewing community or private reviewing community. The trustworthiness of the seller depends on the trust that is placed on the trusted agent who issued the certificates, as the trusted agent has accurately to assess and verify the identity and properties participants.

The aggregated service provider then verifies the property certificate in operation 123. The verification process uses the public and private key mechanism in the PKI infrastructure to affirm the identity of the potential seller. In operation 130, the aggregated service provider selects the potential seller based on the credential information that is encoded in the property certificate. The properties may be weighted so that the aggregated service provider can rank the potential sellers accordingly and select a single or a handful of best sellers to proceed with the process.

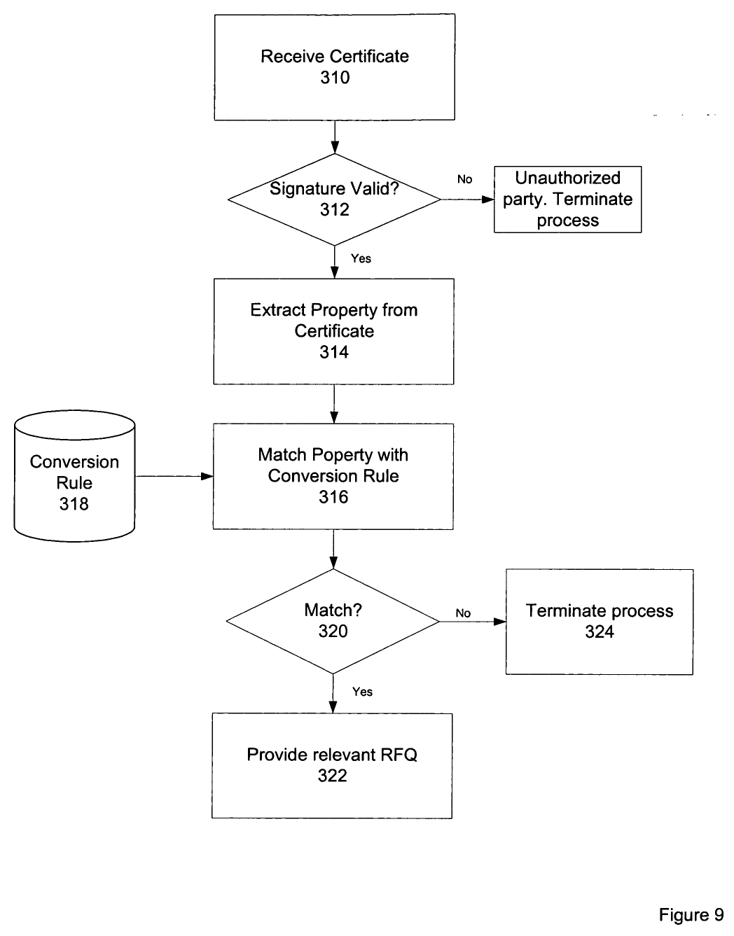

In operation 135, a security policy converts the properties in the digital certificate of the selected sellers into authorization for accessing specific RFQ. The security policy is illustrated in FIG. 9 and further discussed in the section below.

The aggregated service provider prepares the RFQ and encrypts the RFQ in operation 141. In one embodiment, the RFQ may be encrypted with the necessary keys in the property certificate that was submitted by the seller in operation 122. The encrypted RFQ is then sent to the identified seller in operation 140.

When the seller receives the RFQ, it decrypts the RFQ with its private key in operation 150 and may choose to respond with a proposal. Therefore, by deploying the PKI infrastructure, the process is made secure.

The aggregated service provider receives proposals from various sellers and compiles the proposals as a single proposal in operation 160. For example, the aggregated service provider receives a proposal on wire from seller A and a proposal on motor from seller B. The aggregated service provider combines the proposals and presents them as a compiled proposal to be submitted to the buyer. The buyer receives the compiled proposal in operation 180.

In another similar approach of establishing trustworthy relationship among the business participants, the seller may need to verify the buyer or the aggregated service provider. For example, a buyer may request for an exclusive relationship with a seller, whereby the seller is not allowed to supply service or products to a competitor of the buyer. Therefore, the seller may need to evaluate the credentials of the buyers or the aggregated service provider before engaging in an exclusive relationship.

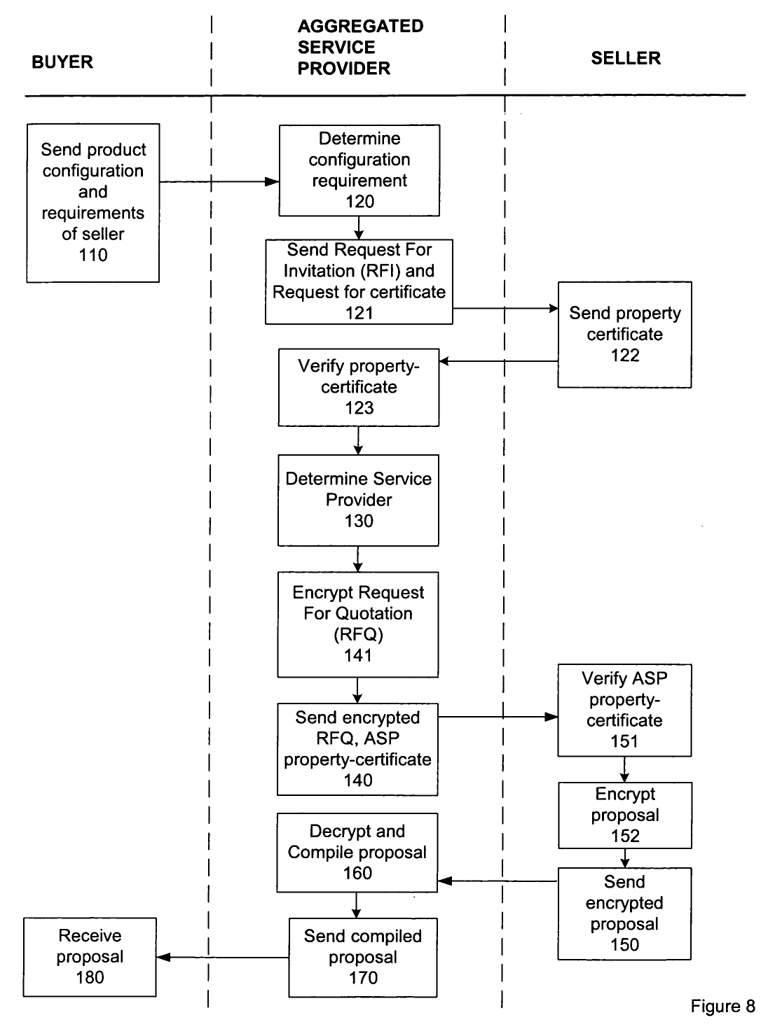

FIG. 8 illustrates such an approach, whereby the seller verifies the credentials of the aggregated service provider before the seller responds with a proposal. Referring to operation 140, the aggregated service provider sends his property certificate together with the encrypted RFQ to the potential sellers. The protocol may be in the form of SendPartRequest(encryptedRFQ, ASP_property_certificate). The seller verifies the property certificate of the aggregated service provider in operation 151. Based on the credentials encoded in the certificate, the seller may then determine whether to respond with a quotation. The seller encrypts the proposal in operation 152 with an appropriate set of public keys contained in the certificate of the aggregated service provider. The aggregated service provider decrypts the proposal in operation 160 and sends the compiled proposal to the buyer in operation 170.

In another exemplary approach, the seller may have different versions of proposal for the same part. Based on the certificate presented by the aggregated service provider, the seller may use a conversion policy to match the property of the aggregated service provider to a relevant version of the proposal. For example, an aggregated service provider that has properties reflecting its financial establishment may receive a proposal that contains better pricing.

While FIG. 8 shows an exemplary embodiment for a typical business process, it should be noted that the operations may be altered to meet the needs of the business transaction. For example, the operation 151 of verifying the property certificate of the aggregated service provider may take place much earlier, such as prior to operation 122 when the seller submits his certificate. In addition, the process may be applied to verify the credentials of a buyer.

Security Architecture—Security Policy

FIG. 9 illustrates an exemplary embodiment of the security policy used to convert the properties in the digital certificate into authorization for accessing specific RFQs. A seller who meets the required properties can only access the RFQ that he is qualified to respond to. With this approach, the seller is also protected from irrelevant information, such as requirements that do not pertain to him.

When an aggregated service provider receives a digital certificate at operation 310, it first verifies if the signature is valid in operation 312. This authenticates the identity of the seller. The security policy extracts the properties from the certificate in operation 314. In operation 316, the properties are matched according to the conversion rules which are stored in a secure file or database. The conversion rules specify the types of RFQ or other documents that the seller may access. When a match occurs in operation 320, the relevant RFQ will be provided in operation 322. For example, a seller submits properties A-C, A-D and E-F. The conversion rule translates the properties and matches the A-C property to the RFQ pertaining to engine fan and the A-D property to the RFQ pertaining to engine motor. However, the conversion rule does not recognize the property E-F and therefore property E-F does not entitle the seller to access any RFQ.

Similarly, the security policy may be applied to verify the credentials of an aggregated service provider or a buyer, and convert the properties to access rights to the relevant documents.

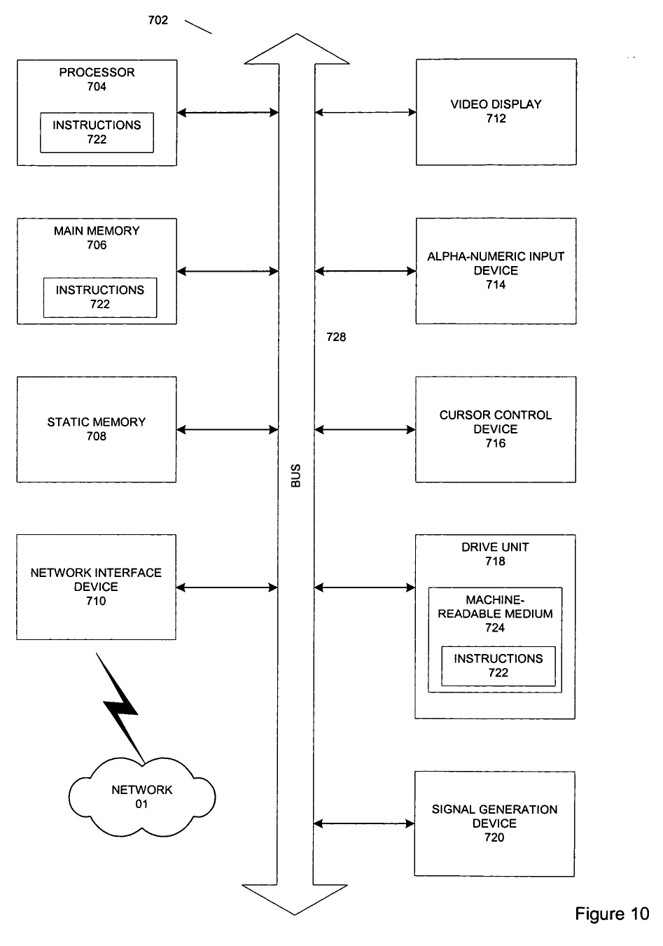

FIG. 10 shows a diagrammatic representation of a machine in the exemplary form of a computer system 702 within which a set of instructions for causing the machine to perform any one or more of the above methodologies may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 702 includes a processor 704 (e.g., a central processing unit (CPU) a graphics processing unit (GPU) or both), a main memory 706 and a static memory 708, which communicate with each other via a bus 728. The computer system 702 may further include a video display unit 712 (e.g., a liquid crystal display (LCD) or a cathode ray tube (CRT)). The computer system 702 also includes an alphanumeric input device 714 (e.g., a keyboard), a cursor control device 716 (e.g., a mouse), a disk drive unit 718, a signal generation device 720 (e.g., a speaker) and a network interface device 710

The disk drive unit 718 includes a machine-readable medium 724 on which is stored one or more sets of instructions (e.g., software 722) embodying any one or more of the methodologies or functions described herein. The software 722 may also reside, completely or at least partially, within the main memory 706 and/or within the processor 704 during execution thereof by the computer system 702, the main memory 706 and the processor 704 also constituting machine-readable media.

The software 722 may further be transmitted or received over a network 01 via the network interface device 710.

While the machine-readable medium 724 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Thus, a method and system to establish a trustworthy seller has been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. A method for automatically evaluating a participant in a trust management infrastructure, the method including:
building a property certificate; and
establishing a security conversion policy that translates a property in the property certificate into a right to access a protected item, wherein the property represents a qualification of the participant.

2. The method of claim 1, wherein the building of the property certificate includes:
assessing a qualification of the participant;
encoding the qualification as the property in the property certificate; and
issuing the property certificate.

3. The method of claim 2, wherein the assessing the qualification of the participant includes determining at least one of financial status, reputation, on-time delivery, price quality, product quality and credit terms of the participant.

4. The method of claim 3, further including classifying the qualification as one of a mandatory property type and an optional property type.

5. The method of claim 4, wherein the property is weighted.

6. The method of claim 1, wherein the building of the property certificate is performed by a trusted agent.

7. The method of claim 6, wherein the trusted agent is at least one of a Certification Authority, financial institute, a government board, a public reviewing community and a private reviewing community.

8. The method of claim 1, wherein the establishing the security conversion policy further includes:
receiving the property certificate;
verifying a signature of the property certificate;
extracting the property from the property certificate;
matching the property with a conversion rule; and
providing the right to access the protected item according to the conversion rule.

9. The method of claim 8, wherein the protected item is at least one of a digital resource, a document and a physical device.

10. The method of claim 1, wherein the participant is at least one of a buyer, an aggregated service provider and a seller.

11. The method of claim 1, wherein the trust management infrastructure is a public key infrastructure (PKI).

12. A method for automatically evaluating a seller in a trust management infrastructure, the method including:
building a seller property certificate;
establishing a security conversion policy;
receiving the seller property certificate in response to an invitation for quotation;
utilizing the security conversion policy to translate a property in the seller property certificate into an access right to a request for quotation;
sending the request for quotation to the seller; and
receiving a proposal from the seller, wherein the property represents a qualification of the seller.

13. The method of claim 12, wherein the building of the seller property certificate includes:
assessing the qualification of the seller;
encoding the qualification as the property in the seller property certificate; and
issuing the seller property certificate.

14. The method of claim 13, wherein the assessing the qualification of the seller includes determining at least one of financial status, reputation, on-time delivery, price quality, product quality and credit terms of the seller.

15. The method of claim 14, further including classifying the qualification as at least one a mandatory property type and an optional property type.

16. The method of claim 15, wherein the property is weighted.

17. The method of claim 12, wherein the building of the seller property is performed by a trusted agent.

18. The method of claim 17, wherein the trusted agent is at least one of a Certification Authority, financial institute, a government board, a public reviewing community and a private reviewing community.

19. The method of claim 12, wherein the establishing the security conversion policy further includes:
receiving the seller property certificate from the seller;
verifying a signature of the seller property certificate;
extracting the property from the seller property certificate;
matching the property with a conversion rule; and
providing the right to access the request for quotation according to the conversion rule.

20. The method of claim 12, further including automatically evaluating a participant requesting the proposal from the seller.

21. The method of claim 20, wherein the participant is at least one of a buyer and an aggregated service provider.

22. The method of claim 20 further including:
building a participant property certificate;
establishing a participant conversion policy;
receiving the participant property certificate with the request for quotation; and
utilizing the participant conversion policy to translate a property in the participant property certificate into a right to access the proposal, wherein the property represents a qualifications of the participant.

23. The method of claim 12, wherein the trust management infrastructure is a public key infrastructure (PKI).

24. A buyer and a seller network system for automatically evaluating a seller, the system including:
means for building a seller property certificate;
means for establishing a security conversion policy;
means for receiving the seller property certificate in response to an invitation for quotation;
means for utilizing the security conversion policy to translate a property in the seller property certificate into a right to access the request for quotation;
means for sending a request for quotation to the seller; and
means for receiving a proposal from the seller, wherein the property represents a qualification of the seller.

25. The system of claim 24, wherein the means for building the seller property certificate includes:
means for assessing the qualification of the seller;
means for encoding the qualification as the property in the seller property certificate; and
means for issuing the seller property certificate.

26. The system of claim 25, wherein the means for assessing the qualification of the seller includes means for determining at least one of financial status, reputation, on-time delivery, price quality, product quality and credit terms of the seller.

27. The system of claim 26, further including means for classifying the qualification as at least one of a mandatory property type and an optional property type.

28. The system of claim 27, wherein the property is weighted.

29. The system of claim 24, wherein the means for building the seller property certificate is performed by a trusted agent.

30. The system of claim 29, wherein the trusted agent is at least one of a Certification Authority, financial institute, a government board, a public reviewing community and a private reviewing community.

31. The system of claim 24, wherein the means for establishing the security conversion policy further includes:
means for receiving the seller property certificate from the seller;
means for verifying a signature of the seller property certificate;
means for extracting the property from the seller property certificate;
means for matching the property with a conversion rule; and
means for providing the right to access the request for quotation according to the conversion rule.

32. The system of claim 24, further including means for automatically evaluating a participant requesting the proposal from the seller.

33. The system of claim 32, wherein the participant is at least one of a buyer and an aggregated service provider.

34. The system of claim 32 further including:
means for building a participant property certificate;
means for establishing a participant conversion policy;
means for receiving the participant property certificate with the request for quotation; and
means for utilizing the participant conversion policy to translate a property in the participant property certificate into a right to access the proposal, wherein the property represents a qualification of the participant.

35. A buyer and a seller network system for automatically evaluating a seller, the system including:
a certification module to build a seller property certificate;
a security module to establish a security conversion policy and to translate a property of the seller property certificate into a right to access a protected item.

36. The system of claim 35, wherein the protected item is at least one of a digital resource, a document and a physical device.

37. A machine-readable medium comprising instructions, which when executed by a machine, cause the machine to perform a method to evaluate a seller in a network, the method including:
building a seller property certificate;
establishing a security conversion policy;
receiving the seller property certificate in response to an invitation for quotation;
utilizing the security conversion policy to translate a property in the seller property certificate into an access right to a request for quotation;
sending the request for quotation to the seller; and
receiving a proposal from the seller.

38. The machine-readable medium of claim 37, wherein the building of the seller property certificate includes:
assessing a qualifications of the seller;
encoding the qualifications as the property in the seller property certificate; and
issuing the seller property certificate.

39. The machine-readable medium of claim 37, wherein the establishing the security conversion policy further includes:
receiving the seller property certificate from the seller;
verifying a signature of the seller property certificate;
extracting the property from the seller property certificate;
matching the property with a conversion rule; and
providing the right to access the request for quotation according to the conversion rule.
